(19) United States
(12) Patent Application Publication
(10) Pub. No.: US 2015/0207314 A1
(43) Pub. Date: Jul. 23, 2015

(54) PROTECTING DEVICE FOR PROTECTING A CIRCUIT AGAINST OVERVOLTAGE AND POWER SUPPLY MEMBER COMPRISING SUCH A DEVICE

(71) Applicant: MERSEN France SB SAS, SAINT-BONNET-DE-MURE (FR)

(72) Inventors: Dominique TOURNIER, LYON (FR); Gianfranco DE PALMA, ST BARTHELEMY D'ANJOU (FR)

(21) Appl. No.: 14/592,186

(22) Filed: Jan. 8, 2015

(30) Foreign Application Priority Data
Jan. 21, 2014 (FR) 1450455

(51) Int. Cl. H02H 9/04

(52) U.S. Cl. CPC H02H 9/042

(57) ABSTRACT

The device for protecting a circuit includes a nonlinear resistance and a Zener diode. The nonlinear resistance is designed to be connected to the terminals of a power supply source of the circuit. The Zener diode and the nonlinear resistance each includes a first connecting end and a second connecting end. The first end of the Zener diode is connected to the second end of the nonlinear resistance. The device further includes a current limiter component, able to limit the intensity of the current passing through it. The current limiter component is connected between the second end of the nonlinear resistance and the second end of the Zener diode.

### FIELD OF THE INVENTION

The present invention relates to a device for protecting a circuit against overvoltage, i.e., a device designed to clip the voltage applied across the terminals of the circuit, and a power supply member comprising such a device.

### BACKGROUND OF THE INVENTION

One issue in the field of electrical circuits is the protection of the electrical circuit against overvoltage, in order to ensure proper operation of the electrical circuits and the components making up said electrical circuits. In fact, overvoltages applied between two terminals of an electrical circuit can cause the circuit to be destroyed. The overvoltage generally comes from electrostatic discharges that may be applied across the terminals of the electrical circuit.

In the field of protection against overvoltage, it is known to use components such as nonlinear resistances or Zener diodes. Zener diodes more specifically correspond to power Zener diodes, the rated power of which is for example greater than 10 W.

The nonlinear resistance, for example when it is connected in parallel with a circuit to be protected against overvoltage, makes it possible to dissipate the energy due to the overvoltage, while limiting the voltage across the terminals of said circuit. However, the voltage limitation, also called voltage clipping, offered by the nonlinear resistance is limited.

The power Zener diode has a very good voltage clipping power and therefore makes it possible to limit the voltage across the terminals of the circuit to be protected against the overvoltage. However, the capacity of the power Zener diode to dissipate the surplus energy due to the overvoltage is very limited, which can lead to destruction of the power Zener diode if an overvoltage appears.

In FIG. 3, the graph shows a current-voltage characteristic of the nonlinear resistance on a curve 100 and a current-voltage characteristic of the power Zener diode on a curve 102. Curves 100, 102 illustrate the limited voltage clipping capacity of the nonlinear resistance and show that the power Zener diode has a better voltage clipping capacity than the nonlinear resistance. In fact, for negative currents, at the conduction zone 104 of the nonlinear resistance and the power Zener diode, the slope of curve 102 is greater than the slope of curve 100.

It is also known to use a device comprising a power Zener diode connected in parallel with a nonlinear resistance. The power Zener diode [is] then connected across the terminals of the electrical circuit to be protected against overvoltages. However, in such a device, when the voltage across the terminals of the nonlinear resistance increases significantly due to an overvoltage, the voltage across the terminals of the power Zener diode also increases considerably, which leads to the destruction of the power Zener diode. Furthermore, in this type of device, a first rated voltage value chosen for the power Zener diode depends on a second rated voltage value chosen for the nonlinear resistance.

The aim of the invention is therefore to propose a device for protecting a circuit against overvoltage, and making possible to improve the dissipation of excess energy related to the appearance of an overvoltage, as well as clipping of the voltage across the terminals of the circuit.

### SUMMARY OF THE INVENTION

To that end, the invention relates to a device for protecting a circuit against overvoltage, the device comprising a nonlinear resistance and a Zener diode, the nonlinear resistance being designed to be connected to the terminals of a power supply source of the circuit, the Zener diode and the nonlinear resistance each comprising a first connecting end and a second connecting end, the first end of the Zener diode being connected to the first end of the nonlinear resistance. According to the invention, the device further comprises a current limiter component, able to limit the intensity of a current passing through it, the current limiter component being connected between the second end of the nonlinear resistance and the second end of the Zener diode.

Owing to the invention, when an overvoltage appears, the intensity of the current coming out of the current limiter component is limited, which makes it possible to limit the intensity of the current passing through the Zener diode, for example below an intensity value past which its diode may be destroyed. Thus, when the overvoltage appears, a current peak appears and the current limiter component is passed through by part of the current, while it blocks another part of the current that passes through the nonlinear resistance. The nonlinear resistance is then able to dissipate the excess energy related to the overvoltage. Furthermore, the Zener diode has a very high voltage clipping power, which makes it possible to protect the circuit well against the overvoltage. The proposed device therefore makes it possible to better protect the circuit against overvoltage while avoiding destruction of the Zener diode.

According to other advantageous aspects of the invention, the protection device further comprises one or more of the following features, considered alone or according to any technically acceptable combination(s):
The Zener diode is connected to the terminals of the circuit.
The current limiter component comprises a field effect transistor such as a JFET transistor or a MOS transistor.
The field effect transistor includes a semiconductor substrate made from a material with a wide band gap, corresponding to silicon or silicon carbide.
The field effect transistor is a VJFET (Vertical Junction FET) with a substrate made from silicon carbide.
The Zener diode is a Transil diode.
The nonlinear resistance is a varistor.
The rated voltage of the nonlinear resistance is greater than the voltage delivered by the power supply source, preferably at least 1.5 times greater than said voltage delivered by the supply source.
The current limiter component can limit the intensity of the current passing through it to a value below or equal to a threshold value, and the Zener diode can be passed through by a current whose intensity is greater than or equal to said threshold value.

The invention also relates to a power supply member comprising a power supply source and a device for protecting a circuit against overvoltage. According to the invention, the protection device is as defined and the nonlinear resistance is connected to the terminals of the power supply source.

### BRIEF DESCRIPTION OF THE DRAWINGS

The invention will be better understood, and other advantages thereof will appear, in light of the following description, provided solely as a non-limiting example, and done in reference to the drawings, in which:

FIG. 1 is a diagrammatic illustration of an electrical system comprising a protection device according to the invention, connected to an electrical circuit to be protected from overvoltage;

FIG. 2 is a set of two curves showing, when an overvoltage appears, the current as a function of time, as input and output, respectively, of a current limiter component belonging to the protection device of FIG. 1;

FIG. 3 is a set of two curves showing the current-voltage characteristic of a Zener diode and a nonlinear resistance, respectively.

### DETAILED DESCRIPTION OF THE INVENTION

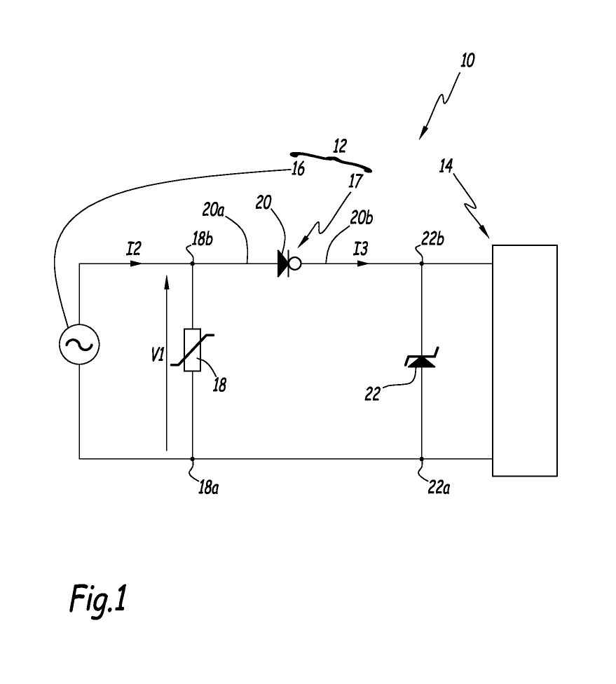

In FIG. 1, an electrical system 10 comprises a power supply 12 and an electrical circuit 14 to be protected against overvoltage.

The power supply circuit 12 comprises a power supply source 16 and a protection device 17.

The power supply source 16 is a voltage supply source. The power supply source 16 is suitable for supplying a voltage V1 that can be applied across the terminals of the circuit 14 without damaging it. The voltage V1 is generally comprised between 24 Volts (V) and 1500 V, preferably between 24 V and 1000 V.

The protection device 17 comprises a nonlinear resistance 18, a current limiter component 20 and a Zener diode 22. The Zener diode 22 generally corresponds to a power Zener diode whose rated power is for example greater than 10 W.

The nonlinear resistance 18 is connected to the terminals of the power supply source 16, i.e., in parallel with the power supply source 16. The nonlinear resistance 18 is preferably a varistor.

The nonlinear resistance 18 comprises a first connecting end 18a and a second connecting end 18b.

The nonlinear resistance 18a has a rated voltage Vn greater than the voltage V1 delivered by the power supply source 16. The rated voltage Vn corresponds to the voltage across the terminals of the nonlinear resistance when it is passed through by a current equal to 1 mA. Preferably, the rated voltage Vn is at least 1.5 times greater than the voltage V1 delivered by the power supply source 16. Thus, if the voltage V1 is equal to 100 V, the rated voltage Vn is for example equal to 150 V.

The current limiter component 20 comprises a first connection end 20a and a second connection end 20b. The first end 20a of the limiter component 20 is connected to the second end 18b of the nonlinear resistance 18.

The current limiter component 20 can limit the intensity of a current passing through it and thereby limit the intensity of the current transmitted at the second connecting end 20b.

The current limiter component 20 can limit the intensity of the current passing through it to a value less than or equal to a threshold value S1. More specifically, when a current whose intensity is greater than the threshold value S1 arrives at the input of the current limiter component 20, the component 20 can limit the intensity of the current passing through it to a threshold value S1. The threshold value S1 is generally chosen such that the intensity of the current passing through the second end 20b is less than or equal to a maximum acceptable intensity Imax for the circuit 14. The maximum intensity Imax corresponds to the maximum intensity of a current able to pass through the circuit 14 without damaging or altering its operation. The threshold value S1 is for example comprised between 5 A and 200 A.

The current limiter component 20 comprises a field effect transistor, not shown, such as a junction field effect transistor (JFET) or a metal oxide silicon field effect transistor (MOSFET).

The transistor comprises a semiconductor substrate made from a material with a wide band gap for example corresponding to silicon or silicon carbide.

Preferably, the field effect transistor is a junction field effect transistor (JFET), also called a junction gate field effect transistor.

Also preferably, the field effect transistor is a vertical junction field effect transistor (VJFET) whose substrate is a silica carbide.

The current limiter component 20 is as described in patent application FR-A1-2975542. Thus, the transistor comprises a drain electrode, a source electrode and a gate electrode.

Alternatively, the current limiter component 20 comprises a bipolar transistor, such as an insulated gate bipolar transistor (IGBT), or any other type of component able to limit, i.e., clip, the current passing through it. The Zener diode 22 comprises a first connecting end 22a and a second connecting end 22b. The Zener diode 22 is connected across the terminals of the circuit 14, i.e., in parallel with the circuit 14.

The first end 22a is connected to the first end 18a. The second end 22b of the Zener diode is connected to the second end 20b of the current limiter component 20.

The current limiter component 20 is thus connected between the second end 18b of the nonlinear resistance 18 and the second end 22b of the Zener diode 22. More specifically, the source electrode is connected to the second end 18b of the nonlinear resistance 18, the drain electrode is connected to the second end 22b of the Zener diode 22, and a gate electrode is connected to a control member, not shown, able to set the threshold value S1 to a predetermined value.

The Zener diode 22 is preferably a Transil diode.

The Zener diode 22 can be passed through by a first current I1 whose intensity is greater than or equal to said threshold value S1. The values of the first current I1 and the threshold S1 are specific to the circuit 14 to be protected and the rated currents and voltages passing through it.

Alternatively, the Zener diode 22 can generally be passed through by the first current I1, whose intensity is greater than the difference between the threshold value S1 and the intensity of a rated current In able to pass through the circuit 14. The rated current In corresponds to the current necessary for optimal operation of the circuit 14.

During normal operation of the circuit 14 and the supply source 16, i.e., when no overvoltage appears, the limiter component 20 does not limit the current passing through it and the supply source 16 delivers its voltage V1 directly to the circuit 14, since the current passing through the nonlinear resistance 18 and the Zener diode 22 is very low and can be considered null.

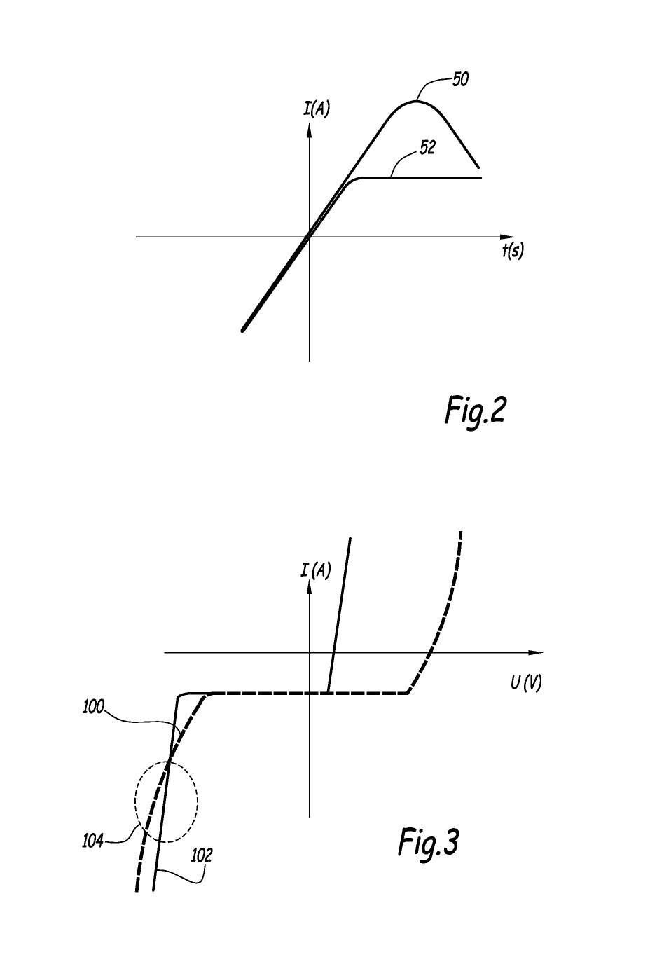

In FIG. 2, curve 50 shows the second current I2 as a function of time measured at the power supply source 16, when an overvoltage appears, and curve 52 shows a third current I3 as a function of time measured at the second terminal 20b of the current limiter component 20, when the overvoltage appears.

Curve 50 shows that when the overvoltage appears, the current at the power supply source 16 increases considerably. Curve 52 shows that when the overvoltage appears, the current measured at the second terminal 20b reaches the threshold value S1. Thus, the current arriving at the second end 22b of the Zener diode 22 and the circuit 14 is limited to the threshold value S1 and, as a result, the current passing through the Zener diode 22 and the circuit 14 do not negatively influence their operation.

Indeed, the threshold value S1 is chosen so as to be less than or equal to the intensity of the first current I1 able to pass through the Zener diode 22. Furthermore, the threshold value S1 is generally chosen to be greater than the intensity of the rated current In that can pass through the circuit 14. Thus, the current limiter component 20 limits the current passing through it only when a current peak corresponding to an overvoltage appears.

When an overvoltage occurs, the current passing through the limiter component 20 being limited to the threshold value S1, the nonlinear resistance 18 is passed through by a current corresponding to a remaining current Ir, which is blocked by the current limiter component 20 and does not pass through it. The remaining current Ir corresponds to the difference between the amplitude of the curve 50 and the threshold value S1, when the curve 50 has an amplitude greater than the curve 52. The nonlinear resistance 18 makes it possible to dissipate the energy corresponding to the remaining current Ir, i.e., to dissipate energy related to the overvoltage.

Furthermore, the Zener diode 22 makes it possible to optimize the clipping of the voltage across the terminals of the circuit 14.

Thus, the device 17 allows both optimized clipping of the voltage across the terminals of the circuit 14 and dissipation of the energy related to the overvoltage owing to the nonlinear resistance 18.

Furthermore, the nonlinear resistance 18 has an energy dissipating function, and not a voltage clipping function. Thus, the value of the rated voltage Vn of the nonlinear resistance 18 can be higher than the voltage V1, delivered by the power supply source 16. More specifically, the rated voltage Vn is at least 1.5 times higher than the voltage V1, as previously explained. This means that a significant current passes through the nonlinear resistance 18 only when the overvoltage creates a current above the threshold S1, and not once the voltage across the terminals of the supply source 16 is slightly above the voltage V1, for example 1.2 times higher. Thus, the lifetime of the nonlinear resistance 18 is optimized.

1. A device for protecting a circuit against overvoltage, the device comprising a nonlinear resistance and a Zener diode, the nonlinear resistance being designed to be connected to the terminals of a power supply source of the circuit, the Zener diode and the nonlinear resistance each comprising a first connecting end and a second connecting end, the first end of the Zener diode being connected to the first end of the nonlinear resistance.
wherein the device further comprises a current limiter component, able to limit the intensity of a current passing through it, the current limiter component being connected between the second end of the nonlinear resistance and the second end of the Zener diode.

2. The device according to claim 1, wherein the Zener diode is connected to the terminals of the circuit.

3. The device according to claim 1, wherein the current limiter component comprises a field effect transistor such as a JFET transistor or a MOS transistor.

4. The device according to claim 3, wherein the field effect transistor includes a semiconductor substrate made from a material with a wide band gap, corresponding to silicon or silicon carbide.

5. The device according to claim 3, wherein the field effect transistor is a VJFET (Vertical Junction FET) with a substrate made from silicon carbide.

6. The device according to claim 1, wherein the Zener diode is a Transil diode.

7. The device according to claim 1, wherein the nonlinear resistance is a varistor.

8. The device according to claim 1, wherein the rated voltage of the nonlinear resistance is greater than the voltage delivered by the power supply source.

9. The device according to claim 1, wherein the current limiter component can limit the intensity of the current passing through it to a value below or equal to a threshold value, and wherein the Zener diode can be passed through by a current whose intensity is greater than or equal to said threshold value.

10. A power supply member comprising a power supply source and a device for protecting a circuit against overvoltage,
wherein the device is according to claim 1, and the nonlinear resistance is connected to the terminals of the power supply source.
